(19) United States
(12) Patent Application Publication
(10) Pub. No.: US 2026/0001055 A1
(43) Pub. Date: Jan. 1, 2026

(54) METHOD AND APPARATUS FOR UPGRADING RENEWABLE OIL STREAM

(71) Applicant: UOP LLC, Des Plaines, IL (US)

(72) Inventor: Sathit Kulprathipanja, Schaumburg, IL (US)

(21) Appl. No.: 18/757,729

(22) Filed: Jun. 28, 2024

(51) Int. Cl. B01J 8/18; C10G 11/18

(52) U.S. Cl. CPC B01J 8/1827; B01J 8/1836; C10G 11/18; B01J 2208/00274; C10G 2300/1003; C10G 2300/1014; C10G 2300/1018

(57) ABSTRACT

Methods and apparatus for upgrading renewable oils stream are described. The method involves using a cooling stream surrounding the tip of the renewable feed line to prevent polymerization/coking. The cooling stream, which comprises gases or liquids that can be converted to valuable products such as olefins, flows into the FCC reaction zone where it mixes with the FCC feed stream and the renewable oil. The renewable oil can be atomized with an atomizing gas.

### BACKGROUND

Fluid catalytic cracking (FCC) is a well-known process for the conversion of relatively high boiling point hydrocarbons to lower boiling point hydrocarbons in the heating oil or gasoline range. Such processes are commonly referred to in the art as “upgrading” processes. To conduct FCC processes, FCC units are generally provided that have one or more reaction zones, with a hydrocarbon stream contacted in the one or more reaction zones with a particulate cracking catalyst. The particulate cracking catalyst is maintained in a fluidized state under conditions that are suitable for the conversion of the relatively high boiling point hydrocarbons to lower boiling point hydrocarbons.

While hydrocarbon streams such as vacuum gas oil, reduced crude, or other petroleum-based sources of hydrocarbons have commonly been upgraded through FCC processes, there is a general desire to upgrade biofuels along with the hydrocarbon streams in the FCC processes. By upgrading biofuel along with the hydrocarbon streams, the resulting upgraded fuel includes a renewable content and enables net petroleum-based hydrocarbon content of the upgraded fuel to be decreased.

Biofuels encompass various types of combustible fuels that are derived from organic biomass, and one particular type of biofuel is pyrolysis oil, which is also commonly referred to as biomass-derived pyrolysis oil. Pyrolysis oil is produced through pyrolysis, including through recently-developed fast pyrolysis processes. Fast pyrolysis is a process during which organic biomass, such as wood waste, agricultural waste, etc., is rapidly heated to 450° C. to 600° C. in the absence of air using a pyrolysis unit. Under these conditions, a pyrolysis vapor stream including organic vapors, water vapor, and pyrolysis gases is produced, along with char (which includes ash and combustible hydrocarbon solids). A portion of the pyrolysis vapor stream is condensed in a condensing system to produce a pyrolysis oil stream. Pyrolysis oil is a complex, highly oxygenated organic liquid that typically contains 20-30% by weight water with high acidity (TAN greater than 150).

Due to the high oxygen content of the pyrolysis oils, pyrolysis oils are generally immiscible with hydrocarbon streams. Prior attempts to co-process pyrolysis oil streams and hydrocarbon streams have involved deoxygenation of the pyrolysis oil followed by combining the deoxygenated pyrolysis oil stream and the hydrocarbon stream prior to FCC processing. Such approaches add unit operations, along with added capital costs, to the upgrading process. Further, plugging of feed lines and/or fouling of equipment may still remain a concern even after deoxygenating the pyrolysis oils, and feed lines that facilitate introduction of a pyrolysis oil stream into a reaction zone where FCC processing is conducted are prone to clogging. Additionally, feed lines that contain mixtures of a hydrocarbon stream and a pyrolysis oil stream are also generally prone to clogging due to the presence of the pyrolysis oil stream in the feed lines. Simply separating and introducing the hydrocarbon stream and the pyrolysis oil stream into the reaction zone through separate feed lines is ineffective to avoid clogging.

Other renewable oils, as well as other temperature sensitive feeds can cause plugging or fouling of equipment. Renewable oils and temperature sensitive feeds include, but not limited to, vegetable oil, pyrolysis oil, tall oil, tallow oil, recycled polymers, or combinations thereof.

Accordingly, it is desirable to provide methods and apparatuses that enable a mixture of a renewable oil stream and a hydrocarbon stream to be upgraded through catalytic cracking, such as in fluid catalytic cracking units, while avoiding excessive clogging of feed lines.

### BRIEF DESCRIPTION OF THE DRAWINGS

FIG. 1 is an illustration of one embodiment of an FCC unit according to the present invention.

FIG. 2 is an illustration of one embodiment of a renewable oil feed unit according to the present invention.

### DESCRIPTION

One available distributor has small metal surface area with single hole opening at the tip that is exposed to the hot environment inside the FCC riser with cooling gas (N₂ or fuel gas). Providing the distributor tip with cooling gas helps to prevent polymerization/coking at the tip from renewable oils and other temperature sensitive feeds, such as pyrolysis oil including rapid thermal processing (RTP) pyrolysis oil, tall oil, vegetable oil, tallow oil, recycled polymers, or combinations thereof. However, the single opening hole leads to droplets which are larger than desirable. Another distributor has multiple smaller holes around the perimeter on the cover, proprietary internals, and atomizing gas to produce micron size droplets. It was determined that the smaller the droplets introduced into the riser, the faster/better conversion was obtained from these harder to crack feed stock, resulting in less coke lay down on the equipment. This type of distributor can be used for renewable feed as well, but the surface area of the cover is much larger compared to the single hole type, which allows the surface temperature to surpass a predicted polymerization temperature for the renewable feed with the cooling gas as shown in CFD modeling work (e.g., the predicted polymerization temperature for pyrolysis oil made from biomass is 71° C. (160° F.)). Other types of distributors could also be used to provide the appropriate size droplets. Alternatively, more cooling gas could be added, and/or it could be made slightly colder (improvement shown from CFD). However, more cooling gas (N₂ or fuel gas) will impact downstream equipment, which impacts the reliability and capacity of the equipment (e.g., riser, cyclones, main column, overhead condenser/coolers/receiver, wet gas compressor, etc.), which is already a constraint for most units, and which customers do not want to sacrifice. N₂ and off gas take volume from the feed and offer no added value in the FCC process. Another possibility would be to add more holes on the cover and/or reduce the cover surface area, which might help reduce some fouling, but it impacts the spray pattern, droplet sizes, increases the complexity of the system, reduce yields, and increases cost.

The present invention uses a cooling stream that comprises gases and/or liquids that can be converted into valuable products, such as olefins. Suitable gases and liquids for the cooling stream include, but are not limited to, light hydrocarbons. Suitable light hydrocarbons include, but are not limited to, hydrocarbons having 1-6 carbon atoms, liquified petroleum gas, or combinations thereof. The use of light hydrocarbons as a cooling gas and/or liquids can reduce the typical FCC feed, as well as making valuable products such as ethylene or propylene. They can replace N₂ or fuel gas as the cooling gas. In some cases, the cooling gas and/or liquid may include N₂ or fuel gas.

A recycle stream of C3 and/or C4 hydrocarbons can also be used as the atomizing gas for the renewable feed stream. In this case, it is desirable that the C3 and/or C4 hydrocarbons are in the gas phase. At typical riser pressures of 20 to 50 psig at the distributor injection, C3 and/or C4 hydrocarbons will be in the gas phase at 38° C. (100° F.), which is similar to the nitrogen supply temperature from most refineries.

The location of the distributor helps to maximize conversion of the renewable oils to valuable products and increase yield. Without sufficient residence time and optimum conditions, the renewable oil will be hard to crack, leading to limited conversion and increased coke laydown. The ideal location of the renewable oil inlet should be at the same elevation as, or just slightly higher or lower than, the current FCC feed distributors to maximize the conversion while maintaining similar residence time and catalyst to oil ratios as for FCC feed. It is recommended that the renewable oil distributor be placed as close to where the FCC feed stream is introduced into the FCC reaction zone as possible, desirably less than 10 m away, or 8 M, or 7 m, or 6 m, or 5 m, or 4 m, or 3 m, or 2 m, or 1 m. In some cases, the distributor must be located further down from the FCC distributor due to congestion at the desired location.

Using this process, it is possible to increase the amount of renewable oil or other temperature sensitive feed sent to the FCC reaction zone.

Thus, the present invention achieves the goals of cooling the renewable feed distributors to avoid fouling and helping customers increase revenue with valuable products that can be sold.

The following detailed description is merely exemplary in nature and is not intended to limit the invention or the application and uses of the invention. Furthermore, there is no intention to be bound by any theory presented in the preceding background or the following detailed description.

Methods and fuel processing apparatuses for upgrading a renewable oil stream and a hydrocarbon stream are provided herein. As referred to herein. “upgrading” refers to conversion of relatively high boiling point hydrocarbons to lower boiling point hydrocarbons. Upgrading processes generally render the hydrocarbon stream and the renewable oil stream suitable for use as a transportation fuel. In the methods and fuel processing apparatuses described herein, a mixture of the renewable oil stream and the hydrocarbon stream are catalytically cracked in a reaction zone in the presence of a particulate cracking catalyst. The reaction zone, as referred to herein, is an area or space where particulate cracking catalyst is comingled along with the renewable oil stream and/or the hydrocarbon stream. Catalytic cracking is conducted at temperatures in excess of 100° C., and the hydrocarbon stream is generally provided at temperatures in excess of 100° C. However, renewable oil generally polymerizes at temperatures in excess of 100° C. and forms deposits within the apparatuses. Deposit formation is a concern in the reaction zone and in the feed lines that lead to the reaction zone. In particular, deposit formation in the reaction zone generally results in deposited compounds forming on the riser, particulate cracking catalyst, and other equipment. The particulate cracking catalyst may be regenerated through conventional processes even with high amounts of deposited compounds present thereon, but operation of the fuel processing apparatus is impacted by formation of deposited compounds on the particulate cracking catalyst. In addition, deposit formation in the feed lines that lead to the reaction zone may result in plugging, which requires shutdown of the fuel processing apparatus and cleanout of the plugged feed lines. Therefore, to minimize deposit formation attributable to polymerization within the renewable feed stream in the feed lines that lead to the reaction zone, the methods and fuel processing apparatus that are described herein are adapted to minimize the temperature rise of the renewable feed stream until the renewable feed stream is clear of structure upon which deposit formation could cause plugging or clogging.

To minimize the temperature rise of the renewable feed stream in accordance with the methods and fuel processing apparatuses described herein, the renewable feed stream and the FCC hydrocarbon feed stream are separately introduced into the reaction zone, optionally in the presence of a carrier gas, and the temperature of the renewable oil stream is maintained at a temperature of less than or equal to 100° C., or less than or equal to 80° C., or less than or equal to 70° C., or less than or equal to 60° C., or less than or equal to 50° C., or less than or equal to 40° C., or less than or equal to 30° C. or less than or equal to 20° C. or less than or equal to 10° C. substantially up to introduction into the reaction zone. The temperature of the renewable oil stream can be maintained in a variety of different ways as described in further detail below. Without being bound by any particular theory, it is believed that a temperature rise in the renewable oil stream above 100° C. results in excessive deposit formation due to polymerization within the renewable oil stream. By maintaining the temperature of the renewable oil stream at the temperature of less than or equal to 100° C. substantially up to introduction into the reaction zone, deposit formation prior to introducing the renewable oil stream into the reaction zone is minimized at least while the renewable oil stream is in contact with structures within the fuel processing apparatuses outside of the reaction zone, where deposit formation could cause clogging.

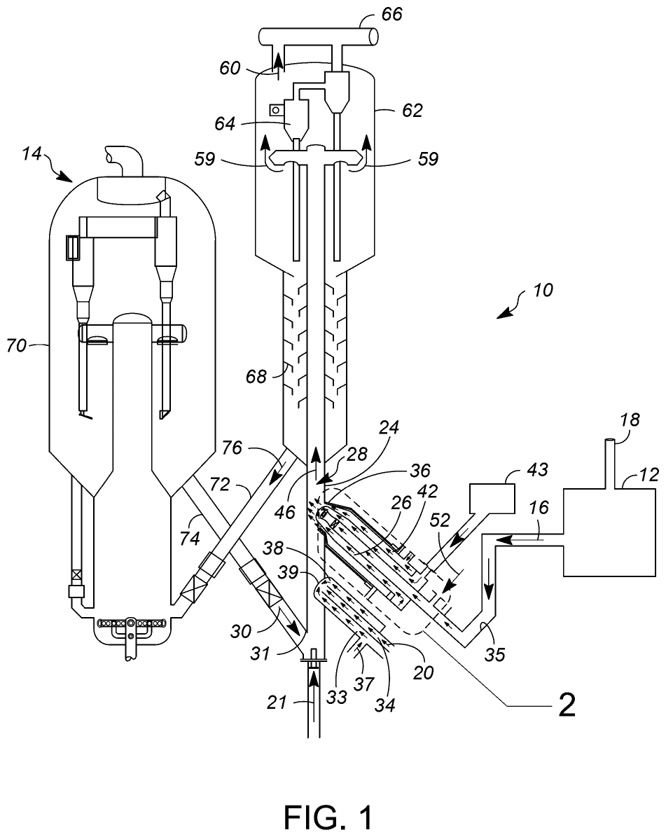

An exemplary embodiment of a method for preparing upgraded renewable oil will now be addressed with reference to an exemplary fuel processing apparatus 10 as shown in FIG. 1. In this embodiment, the fuel processing apparatus 10 includes a pyrolysis unit 12 and a fluid catalytic cracking (FCC) unit 14. The pyrolysis unit 12 provides a renewable feed stream 16 by pyrolyzing a biomass stream 18 to produce the renewable feed stream 16. One example of a pyrolysis method is fast pyrolysis in which the biomass stream 18, such as wood waste, agricultural waste, biomass that is purposely grown and harvested for energy, and the like, is rapidly heated to 450° C. to 600° C. in the absence of air in the pyrolysis unit 12. Under these conditions, a pyrolysis vapor stream including organic vapors, water vapor, and pyrolysis gases is produced, along with char (which includes ash and combustible hydrocarbon solids). A portion of the pyrolysis vapor stream is condensed in a condensing system within the pyrolysis unit 12 to produce the renewable feed stream 16. The renewable feed stream 16 is a complex, organic liquid having an oxygen content, and may also contain water. For example, the oxygen content of the renewable feed stream 16 can be from 30 to 60 weight %, such as from 40 to 55 weight %, based on the total weight of the renewable feed stream 16. Water can be present in the renewable feed stream 16 in an amount of from 10 to 35 weight %, such as from 20 to 32 weight %, based on the total weight of the renewable feed stream 16. It is to be appreciated that in other embodiments, although not shown, the renewable feed stream 16 may be provided from any source of renewable oil, such as a vessel that contains the renewable feed stream 16, and the methods described herein are not limited to providing the renewable feed stream 16 from any particular source. In an embodiment, the renewable feed stream 16 is provided from the pyrolysis unit 12 at a temperature of less than or equal to 100° C., such as less than or equal to 80° C., to minimize polymerization of the renewable feed stream 16 that could lead to deposit formation after leaving the pyrolysis unit 12.

In accordance with the exemplary method contemplated herein, an FCC feed stream 20 is also provided. As referred to herein, the FCC feed stream refers to a petroleum-based source of hydrocarbons. The FCC feed stream 20 is provided separate from the renewable feed stream 16, with the renewable feed stream 16 and the FCC feed stream 20 separately introduced into a FCC reaction zone 28 as described in further detail below. The FCC feed stream 20 can include a fresh stream of hydrocarbons or a refined stream of hydrocarbons from other refinement operations. In an embodiment, the FCC feed stream 20 is vacuum gas oil, which is a common FCC feed stream 20 that is upgraded in FCC units. It is to be appreciated that the FCC feed stream 20 may be provided from any source, and the methods described herein are not limited to providing the FCC feed stream 20 from any particular source. Suitable sources of feed to the FCC unit include, but are not limited to, resid feed, hydrotreated feed, atmospheric tower feed, crude feed, and the like. In embodiments, the FCC feed stream 20 is provided at a temperature that is higher than the renewable feed stream 16, and is further introduced into the FCC reaction zone 28 at a temperature that is higher than the renewable feed stream 16, because little risk of deposit formation from the FCC feed stream 20 exists due to elevated temperatures and because elevated temperatures of the FCC feed stream 20 promote catalytic cracking. In an embodiment, the FCC feed stream 20 is provided at a temperature of at least 100° C., such as from 100 to 425° C., for example from 200 to 300° C.

Referring to FIG. 1, an exemplary embodiment of the FCC unit 14 contemplated herein includes an FCC reaction zone 28, a renewable feed line 35, and an FCC feed line 34. In particular, a particulate cracking catalyst 30 is contacted with a mixture 46 of the FCC feed stream 20, the renewable feed stream 16, and the cooling stream 42 in the FCC reaction zone 28. The renewable feed line 35 has a renewable feed line outlet 36 into the FCC reaction zone 28 for introducing the renewable feed stream 16 into the FCC reaction zone 28. The lift medium 21 flows upward and carries the particulate cracking catalyst 30 upward in the FCC reaction zone 28. The lift medium 21 may comprise steam, lift gas from a sponge adsorber offgas, light fuel gas, and the like, or combinations thereof.

The FCC feed line 34 is surrounded by an FCC atomizing gas line 33. The FCC atomizing gas 37 mixes with the FCC feed stream 20 in the FCC cover 39, and the mixture is atomized as it flows into the FCC reaction zone 28.

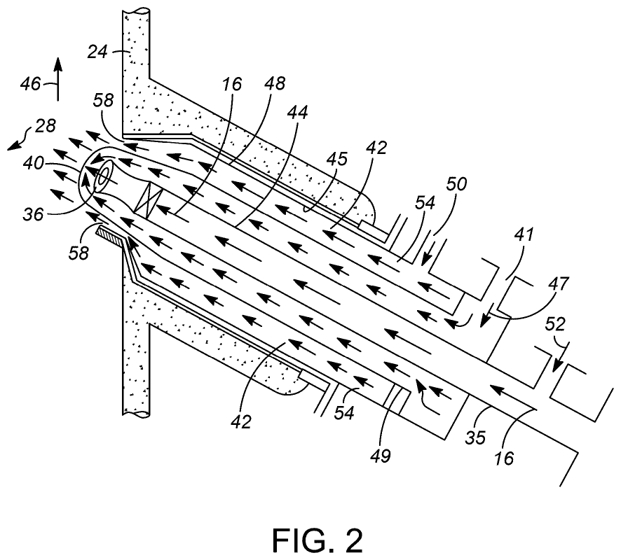

In an embodiment and as shown in FIG. 2, the renewable feed line 35 further includes a renewable feed distribution cover 40 where the renewable feed stream 16 is mixed with the atomizing gas 47, and the mixture is introduced into the FCC reaction zone 28 through the renewable feed distribution cover 40.

As shown in FIG. 1, the FCC feed line 34 has an FCC outlet 38 into the FCC reaction zone 28 for introducing the FCC feed stream 20 and FCC atomizing gas 37 into the FCC reaction zone 28 separate from the renewable feed stream 16. The exemplary method continues with separately introducing the renewable feed stream 16 and the FCC feed stream 20 into the FCC reaction zone 28 to form the mixture 46 of the renewable feed stream 16, the FCC feed stream 20, and the cooling stream 42 in the FCC reaction zone 28.

By separately introducing the renewable feed stream 16 and the FCC feed stream 20 into the FCC reaction zone 28, the temperature rise of the renewable feed stream 16 can be controlled, and the temperature of the renewable feed stream 16 can be maintained at less than or equal to 100° C., substantially up to introduction into the FCC reaction zone 28, e.g., substantially up to the renewable feed line outlet 36 into the FCC reaction zone 28. In this regard, the renewable feed line 35 is adapted to inhibit external heating of the renewable feed stream 16 flowing through the renewable feed line 35. As referred to herein, “substantially up to” refers to a location in the renewable feed line 35 that is adjacent to the renewable feed line outlet 36 into the FCC reaction zone 28, but upstream of the renewable feed line outlet 36 within the renewable feed line 35, such as a closest location in the renewable feed line 35 to the renewable feed line outlet 36 where insulation or active external cooling of the renewable feed line 35 can be implemented. It is to be appreciated that a slight temperature rise above the aforementioned values is permissible, even prior to renewable feed stream 16 passing through the renewable feed line outlet 36, so long as the temperature of the renewable feed stream 16 is maintained at less than or equal to 100° C. substantially up to introduction into the FCC reaction zone 28. In an embodiment, the temperature of the renewable feed stream 16 is maintained at less than or equal to 100° C. by actively cooling the renewable feed stream 16. Active cooling, as referred to herein, means that the renewable feed stream 16 is cooled by a controllable cooling activity that enables the magnitude of cooling to be increased or decreased as opposed to insulating the renewable feed stream 16 using insulation alone.

The atomizing gas tube 49 surrounds the renewable feed line 35. The atomizing gas 47 enters though the atomizing gas tube inlet 41 and flows through the atomizing gas tube 49 to the renewable feed distribution cover 40 where it mixes with the renewable feed stream 16. The mixture is atomized as it exits the renewable feed distribution cover 40.

In some embodiments, active cooling can be conducted by externally cooling the renewable feed stream 16 with an external cooling stream 42. In an embodiment and as shown in FIG. 2, the renewable feed stream 16 and the atomizing gas 47 are externally cooled with the external cooling stream 42 that externally cools the renewable feed line 35 and the atomizing gas tube 49 to thereby inhibit external heating of the renewable feed stream 16. In this embodiment, the external cooling stream 42 is a cooling fluid and can be a liquid or a gas. Hydrocarbons having 1-6 carbon atoms, liquified petroleum gas, or combinations thereof are examples of effective cooling fluids.

The cooling stream 42 buffers the atomizing gas tube 49 and the renewable feed line 35 from exposure to external heat. In an embodiment, as shown in FIGS. 1 and 2, a cooling jacket 48 that supports flow of the cooling stream 42 is disposed the renewable feed line 35 and the atomizing gas tube 49 to allow the cooling stream 42 to contact the wall of the atomizing gas tube 49.

Additionally, as shown in FIG. 2, the cooling stream 42 contacts an exterior wall 45 of the cooling jacket 48 that may be directly exposed to the FCC reaction zone 28 to thereby draw heat from gases that enter around the renewable feed distribution cover 40 from the FCC reaction zone 28, which heat may otherwise result in temperature rise of the renewable feed stream 16 flowing through the renewable feed line 35, thereby minimizing temperature rise of the renewable feed stream 16 that may otherwise occur. The cooling jacket 48 includes a cooling stream inlet 50, a cooling flow channel 54 that is disposed adjacent to the wall of the atomizing gas tube 49, and a cooling jacket outlet 58 adjacent to the renewable feed distribution cover 40. The cooling stream inlet 50 supports flow of the cooling stream 42 into the cooling jacket 48 from a cooling fluid source 43. Once in the cooling jacket 48, the cooling stream 42 flows through the cooling flow channel 54, in contact with the wall of the atomizing gas tube 49. In an embodiment and as shown in FIG. 2, the cooling flow channel 54 extends substantially up to the renewable feed line outlet 36 into the FCC reaction zone 28, and the cooling stream 42 is discharged into the FCC reaction zone 28.

Specific process parameters such as flow rates of the cooling stream 42, inlet temperature of the cooling stream 42, contact surface area between the wall 44 of the renewable feed line 35 and the atomizing gas tube 49, contact surface area between the cooling stream 42 and the wall of the atomizing gas tube 49, contact surface area between the cooling stream 42 and the exterior wall 45 of the cooling jacket 48, cooling stream composition, and other considerations that pertain to maintaining the renewable feed stream 16 at the temperature of less than or equal to 100° C. substantially up to introduction into the FCC reaction zone 28 are design considerations that can be readily determined by those of skill in the art.

In another embodiment, the renewable feed stream 16 may also be internally cooled with a supplemental component 52 that is added to the renewable feed stream 16. The renewable feed stream 16 can be internally cooled in combination with the external cooling of the renewable feed stream 16 to maintain the renewable feed stream 16 at the temperature of less than or equal to 100° C. substantially up to introduction into the FCC reaction zone 28. In an embodiment, the renewable feed stream 16 is internally cooled by adding the supplemental component 52 to the renewable feed stream 16 that is flowing through the renewable feed line 35. In some embodiments, the supplemental component 52 comprises the same light hydrocarbons as the cooling stream 42. Alternatively, the supplemental component 52 can be a carrier gas such as FCC product gas, and/or an inert gas such as nitrogen. The supplemental component 52 is added to the renewable feed stream 16 to assist with introducing the renewable feed stream 16 into the FCC reaction zone 28. The supplemental component 52 and the renewable feed stream 16 are mixed prior to introducing the renewable feed stream 16 into the FCC reaction zone 28 to internally cool the renewable feed stream 16. The supplemental component 52 is provided at a temperature of less than or equal to 100° C., such as less than or equal to 80° C., or less than or equal to 70° C., or less than or equal to 60° C., or less than or equal to 50° C., or less than or equal to 40° C., or less than or equal to 30° C., or less than or equal to 20° C., or less than or equal to 10° C. Because the supplemental component 52 is employed in relatively small amounts compared to the renewable feed stream 16, under conditions in which the renewable feed stream 16 is internally cooled with the supplemental component 52, the supplemental component 52 can be provided at temperatures that are substantially lower than 10° C., depending upon the particular type of carrier gas that is employed to effectuate cooling.

In accordance with an exemplary embodiment of the method contemplated herein, the renewable feed stream 16 produced from pyrolyzing the biomass stream 18 is introduced into the FCC reaction zone 28 in the absence of intervening upgrading processing of the renewable feed stream 16. Intervening upgrading processes include, but are not limited to, deoxygenation, cracking, hydrotreating, and the like. In an embodiment, the renewable feed stream 16 is provided directly as a condensed product stream from the pyrolysis unit 12.

Although the methods described herein are effective for minimizing deposit formation from the renewable feed stream 16 prior to introducing the renewable feed stream 16 into the FCC reaction zone 28, independent of a ratio of the renewable feed stream 16 to the FCC feed stream 20, excessive deposit formation on the particulate cracking catalyst 30 may be avoided by adjusting the ratio at which the renewable feed stream 16 and the FCC feed stream 20 are mixed. In an embodiment, the renewable feed stream 16 and the FCC feed stream 20 are mixed at a weight ratio of the renewable feed stream 16 to the FCC feed stream 20 of from 0.005:1 to 0.2:1, such as from 0.01:1 to 0.05:1. Within the aforementioned weight ratios, the renewable feed stream 16 is sufficiently dilute within the mixture 46 of the renewable feed stream 16, the FCC feed stream 20, and the cooling stream 42 to avoid excessive deposit formation on the particulate cracking catalyst 30, thereby avoiding impact on catalyst activity and selectivity of the particulate cracking catalyst 30 within the fluid catalytic cracking unit 14 or excessive heat generation in the catalyst regenerator 70.

The exemplary method continues with catalytically cracking the mixture 46 of the renewable feed stream 16, the FCC feed stream 20, and the cooling stream 42 in the presence of the particulate cracking catalyst 30. In this regard, the particulate cracking catalyst 30 can first comingle with one of the FCC feed stream 20, the renewable feed stream 16, or the cooling stream 42 before mixing with the other streams. Because the particulate cracking catalyst 30 is generally introduced into the FCC reaction zone 28 at a temperature that is sufficient to facilitate catalytic cracking of the mixture 46 of the renewable feed stream 16, the FCC feed stream 20, and the cooling stream 42, catalytic cracking generally commences when the particulate cracking catalyst 30 is comingled with the FCC feed stream 20, and/or the renewable feed stream 16, and/or the cooling stream 42.

In an exemplary embodiment and as shown in FIG. 1, the FCC reaction zone 28 of the FCC unit 14 is included in a vertical conduit or riser 24. In an embodiment, catalytically cracking the mixture 46 of the renewable feed stream 16, the FCC feed stream 20, and the cooling stream 42 includes comingling the particulate cracking catalyst 30 and the renewable feed stream 16 and/or the FCC feed stream 20 and/or the cooling stream 42 in the FCC reaction zone 28. For example, in an embodiment and as shown in FIG. 1, the FCC feed stream 20 is introduced into the riser 24 from the FCC outlet 38 with the FCC outlet 38 located below the renewable feed distribution cover 40 and the cooling jacket outlet 58. In this embodiment, the particulate cracking catalyst 30 may be introduced into the FCC reaction zone 28 at a catalyst outlet 31 that is upstream of the FCC outlet 38, the renewable feed distribution cover 40, and the cooling jacket outlet 58, resulting in the particulate cracking catalyst 30 first comingling with the FCC feed stream 20 before introducing the renewable feed stream 16 and the cooling stream 42 into the FCC reaction zone 28. Such configuration of the FCC outlet 38, the catalyst outlet 31, the renewable feed distribution cover 40, and the cooling jacket outlet 58 may enable reaction temperatures within the FCC reaction zone 28 to be expediently optimized before introducing the relatively cool renewable feed stream 16 into the FCC reaction zone 28. However, it is to be appreciated that the methods described herein are not particularly limited to the relative locations of the FCC outlet 38, the catalyst outlet 31, the renewable feed distribution cover 40, and the cooling jacket outlet 58 and that any relative location of the FCC outlet 38, the catalyst outlet 31, and the renewable feed distribution cover 40, and the cooling jacket outlet 58 whether upstream, downstream, or at even with each other, is feasible in accordance with the methods described herein.

In an embodiment and as shown in FIG. 2, the renewable feed stream 16 and the cooling stream 42 are introduced into the FCC reaction zone 28 at an angle toward a direction of flow within the riser 24 to minimize contact of the renewable feed stream 16 and/or the cooling stream 42 with a wall of the riser 24 that is opposite to the renewable feed distribution cover 40 and the cooling jacket outlet 58, thereby minimizing deposit formation on the wall of the riser 24 that is attributable to the renewable feed stream 16 and the cooling stream 42. The residence time of the particulate cracking catalyst 30 and the mixture 46 of the renewable feed stream 16, the FCC feed stream 20, and the cooling stream 42 in the riser 24 is generally only a few seconds. General operating conditions for the FCC reaction zone 28 in FCC units are known in the art.

Catalytic cracking of the mixture 46 of the renewable feed stream 16, the FCC feed stream 20, and the cooling stream 42 produces an effluent 59 that includes spent particulate cracking catalyst 76 and a gaseous component 60. The gaseous component 60 includes products from the reaction in the FCC reaction zone 28 such as cracked hydrocarbons, and the cracked hydrocarbons may be condensed to obtain upgraded fuel products that have a range of boiling points. Examples of upgraded fuel products include, but are not limited to, propane, butane, naphtha, light cycle oil, heavy fuel oil, and olefins such as ethylene and propylene. In accordance with an embodiment of the contemplated method, the spent particulate cracking catalyst 76 and the gaseous component 60 are separated. In this embodiment, and as shown in FIG. 1, the FCC unit 14 further includes a separator vessel 62 that is in fluid communication with the FCC reaction zone 28. The separator vessel 62 separates the spent particulate cracking catalyst 76 from the effluent 59. The separator vessel 62 may include a solids-vapor separation device 64, which is normally located within and at the top of the separator vessel 62. The gaseous component 60 of the effluent 59 is separated from the spent particulate cracking catalyst 76 in the separator vessel 62, and the gaseous component 60 may be vented from the separator vessel 62 via a product line 66. Although not shown, the gaseous component 60 may be compressed to obtain the upgraded fuel products, and FCC product gas that is not condensed may be recycled for use as the cooling stream 42 and/or the supplemental component 52 in embodiments. In an embodiment, the spent particulate cracking catalyst 76 falls downward to a stripper 68 that is located in a lower part of the separator vessel 62. The stripper 68 assists with removing deposited compounds from the spent particulate cracking catalyst 76 prior to further catalyst regeneration.

In an embodiment, the FCC unit 14 further includes a catalyst regenerator 70 that is in fluid communication with the separator vessel 62 and that is also in fluid communication with the FCC reaction zone 28. The spent particulate cracking catalyst 76 that is separated from the gaseous component 60 is introduced into the catalyst regenerator 70 from the stripper 68, and deposited compounds are removed from the spent particulate cracking catalyst 76 in the catalyst regenerator 70 by contacting the spent particulate cracking catalyst 76 with oxygen-containing regeneration gas. In one embodiment, the spent particulate cracking catalyst 76 is transferred to the catalyst regenerator 70 by way of a first transfer line 72 connected between the catalyst regenerator 70 and the stripper 68. Furthermore, the catalyst regenerator 70, being in fluid communication with the FCC reaction zone 28, passes regenerated particulate catalyst 30 to the FCC reaction zone 28. In the FCC unit 14 as illustrated in FIG. 1, the particulate cracking catalyst 30 is continuously circulated from the FCC reaction zone 28 to the catalyst regenerator 70 and then again to the FCC reaction zone 28, such as through a second transfer line 74.

### EXAMPLE

Current FCC designs have a lower flow rate for the cooling gas, and it has been shown using CFD modeling that with that flow rate, 50% of the feed distributor cover has a temperature exceeding 71° C. (160° F.) which is when fouling occurs from a renewable feed source. Increasing the cooling gas rate by 40% would decrease the feed distributor cover temperature to less than 71° C. (160° F.), which will prevent or minimize fouling buildup on the cover, and impacting the performance. The 40% increase in the flow rate of the cooling stream of light hydrocarbons can be accepted in the FCC unit because some of the light hydrocarbon will crack in the FCC riser to more valuable products such as propylene and ethylene compare to the use of nitrogen or fuel gas as the cooling gas.

### Specific Embodiments

While the following is described in conjunction with specific embodiments, it will be understood that this description is intended to illustrate and not limit the scope of the preceding description and the appended claims.

A first embodiment of the invention is a method for upgrading a renewable feed stream comprising a renewable oil or a temperature sensitive feed and a fluid catalytic cracking (FCC) feed stream comprising introducing the FCC feed stream into an FCC unit comprising an FCC reaction zone; separately introducing the renewable feed stream into the FCC reaction zone through an outlet of a renewable feed line at the FCC reaction zone; actively cooling and maintaining the renewable feed stream and the outlet of the renewable feed line at a temperature less than or equal to 100° C. substantially up to introduction of the renewable feed stream into the FCC reaction zone with a cooling stream, the cooling stream flowing into the FCC reaction zone and forming a mixture of the FCC feed stream, the renewable feed stream, and the cooling stream in the reaction zone, wherein the cooling stream comprises a light hydrocarbon having a temperature less than or equal to 100° C.; and catalytically cracking the mixture of the FCC feed stream, the renewable feed stream, and the light hydrocarbon in the cooling stream in the presence of a particulate cracking catalyst in the reaction zone. An embodiment of the invention is one, any or all of prior embodiments in this paragraph up through the first embodiment in this paragraph wherein separately introducing the renewable feed stream into the FCC reaction zone comprises mixing the renewable feed stream and a first atomizing gas and injecting the mixture of the renewable feed stream and the first atomizing gas into the FCC reaction zone. An embodiment of the invention is one, any or all of prior embodiments in this paragraph up through the first embodiment in this paragraph wherein the first atomizing gas is introduced through an outlet of a first atomizing gas tube surrounding the renewable oil feed distributor. An embodiment of the invention is one, any or all of prior embodiments in this paragraph up through the first embodiment in this paragraph wherein the cooling stream flows through a cooling assembly into the FCC reaction zone, the cooling assembly comprising a cooling jacket surrounding the renewable feed line up to the outlet of the renewable feed line, an outlet of the cooling jacket located at the FCC reaction zone. An embodiment of the invention is one, any or all of prior embodiments in this paragraph up through the first embodiment in this paragraph wherein the light hydrocarbon comprises hydrocarbons having 1-6 carbon atoms, liquified petroleum gas, or combinations thereof. An embodiment of the invention is one, any or all of prior embodiments in this paragraph up through the first embodiment in this paragraph wherein the renewable feed stream is introduced into the reaction zone at a position less than 10 m from a position at which the FCC feed stream is introduced. An embodiment of the invention is one, any or all of prior embodiments in this paragraph up through the first embodiment in this paragraph further comprising introducing a second cooling stream into the renewable feed stream. An embodiment of the invention is one, any or all of prior embodiments in this paragraph up through the first embodiment in this paragraph wherein the cooling stream is in the form of a gas or liquid. An embodiment of the invention is one, any or all of prior embodiments in this paragraph up through the first embodiment in this paragraph wherein the renewable feed stream is present in an amount up to 90%. An embodiment of the invention is one, any or all of prior embodiments in this paragraph up through the first embodiment in this paragraph wherein the renewable feed stream is present in an amount up to 50%. An embodiment of the invention is one, any or all of prior embodiments in this paragraph up through the first embodiment in this paragraph wherein the renewable feed stream comprises vegetable oil, pyrolysis oil, tall oil, tallow oil, recycled polymers, or combinations thereof. An embodiment of the invention is one, any or all of prior embodiments in this paragraph up through the first embodiment in this paragraph wherein the temperature of the cooling stream is less than or equal to 80° C. and wherein the renewable feed stream and the outlet of the renewable feed line are maintained at a temperature less than or equal to 80° C. substantially up to introduction of the renewable feed stream into the FCC reaction zone.

A second embodiment of the invention is an apparatus for upgrading a renewable oil feed stream and an FCC feed stream comprising an FCC unit comprising an FCC reaction zone having a catalyst inlet, lift medium inlet, an FCC feed inlet, a renewable feed inlet, a cooling stream inlet, and a reaction mixture outlet; a catalyst feed line having an inlet and an outlet, the catalyst feed outlet being in fluid communication with the catalyst inlet of the FCC reaction zone; an FCC feed line having an inlet and an outlet, the FCC feed line outlet being in fluid communication with the FCC feed inlet of the FCC reaction zone; a renewable feed line having an inlet and an outlet, the renewable feed line outlet being in fluid communication with renewable feed line inlet of the FCC reaction zone; a cooling assembly comprising a cooling jacket surrounding the renewable feed line, the cooling jacket comprising an inlet and an outlet, the cooling jacket outlet surrounding the outlet of the renewable feed line, the cooling jacket outlet being in fluid communication with the cooling stream inlet of the FCC reaction zone. An embodiment of the invention is one, any or all of prior embodiments in this paragraph up through the second embodiment in this paragraph further comprising a first atomizing gas tube surrounding the renewable feed line and having an inlet and an outlet, the outlet of the first atomizing gas tube being in fluid communication with the renewable feed line outlet prior to the FCC reaction zone. An embodiment of the invention is one, any or all of prior embodiments in this paragraph up through the second embodiment in this paragraph wherein the first atomizing gas tube is between the renewable feed line and the cooling jacket. An embodiment of the invention is one, any or all of prior embodiments in this paragraph up through the second embodiment in this paragraph wherein the cooling jacket, the renewable feed line, and the first atomizing gas tube are concentric. An embodiment of the invention is one, any or all of prior embodiments in this paragraph up through the second embodiment in this paragraph wherein the renewable feed line inlet to the FCC reaction zone is less than 10 m from the FCC feed inlet to the FCC reaction zone. An embodiment of the invention is one, any or all of prior embodiments in this paragraph up through the second embodiment in this paragraph wherein the renewable feed line further comprises a cooling gas inlet. An embodiment of the invention is one, any or all of prior embodiments in this paragraph up through the second embodiment in this paragraph further comprising an FCC atomizing gas tube surrounding the FCC feed line having an inlet and an outlet, the outlet of the FCC atomizing gas tube being in fluid communication with the FCC feed line outlet prior to the FCC reaction zone.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method for upgrading a renewable feed stream comprising a renewable oil or a temperature sensitive feed and a fluid catalytic cracking (FCC) feed stream comprising:
introducing the FCC feed stream into an FCC unit comprising an FCC reaction zone;
separately introducing the renewable feed stream into the FCC reaction zone through an outlet of a renewable feed line at the FCC reaction zone;
actively cooling and maintaining the renewable feed stream and the outlet of the renewable feed line at a temperature less than or equal to 100° C. substantially up to introduction of the renewable feed stream into the FCC reaction zone with a cooling stream, the cooling stream flowing into the FCC reaction zone and forming a mixture of the FCC feed stream, the renewable feed stream, and the cooling stream in the reaction zone, wherein the cooling stream comprises a light hydrocarbon having a temperature less than or equal to 100° C.; and
catalytically cracking the mixture of the FCC feed stream, the renewable feed stream, and the light hydrocarbon in the cooling stream in the presence of a particulate cracking catalyst in the reaction zone.

2. The method of claim 1 wherein separately introducing the renewable feed stream into the FCC reaction zone comprises:
mixing the renewable feed stream and a first atomizing gas and injecting the mixture of the renewable feed stream and the first atomizing gas into the FCC reaction zone.

3. The method of claim 2 wherein the first atomizing gas is introduced through an outlet of a first atomizing gas tube surrounding the renewable oil feed distributor.

4. The method of claim 1 wherein the cooling stream flows through a cooling assembly into the FCC reaction zone, the cooling assembly comprising a cooling jacket surrounding the renewable feed line up to the outlet of the renewable feed line, an outlet of the cooling jacket located at the FCC reaction zone.

5. The method of claim 1 wherein the light hydrocarbon comprises hydrocarbons having 1-6 carbon atoms, liquified petroleum gas, or combinations thereof.

6. The method of claim 1 wherein the renewable feed stream is introduced into the reaction zone at a position less than 10 m from a position at which the FCC feed stream is introduced.

7. The method of claim 1 further comprising:
introducing a second cooling stream into the renewable feed stream.

8. The method of claim 1 wherein the cooling stream is in the form of a gas or liquid.

9. The method of claim 1 wherein the renewable feed stream is present in an amount up to 90%.

10. The method of claim 1 wherein the renewable feed stream is present in an amount up to 50%.

11. The method of claim 1 wherein the renewable feed stream comprises vegetable oil, pyrolysis oil, tall oil, tallow oil, recycled polymers, or combinations thereof.

12. The method of claim 1 wherein the temperature of the cooling stream is less than or equal to 80° C. and wherein the renewable feed stream and the outlet of the renewable feed line are maintained at a temperature less than or equal to 80° C. substantially up to introduction of the renewable feed stream into the FCC reaction zone.

13. An apparatus for upgrading a renewable oil feed stream and an FCC feed stream comprising:
an FCC unit comprising an FCC reaction zone having a catalyst inlet, lift medium inlet, an FCC feed inlet, a renewable feed inlet, a cooling stream inlet, and a reaction mixture outlet;
a catalyst feed line having an inlet and an outlet, the catalyst feed outlet being in fluid communication with the catalyst inlet of the FCC reaction zone;
an FCC feed line having an inlet and an outlet, the FCC feed line outlet being in fluid communication with the FCC feed inlet of the FCC reaction zone;
a renewable feed line having an inlet and an outlet, the renewable feed line outlet being in fluid communication with renewable feed line inlet of the FCC reaction zone; and
a cooling assembly comprising a cooling jacket surrounding the renewable feed line, the cooling jacket comprising an inlet and an outlet, the cooling jacket outlet surrounding the outlet of the renewable feed line, the cooling jacket outlet being in fluid communication with the cooling stream inlet of the FCC reaction zone.

14. The apparatus of claim 13 further comprising:
a first atomizing gas tube surrounding the renewable feed line and having an inlet and an outlet, the outlet of the first atomizing gas tube being in fluid communication with the renewable feed line outlet prior to the FCC reaction zone.

15. The apparatus of claim 14 wherein the first atomizing gas tube is between the renewable feed line and the cooling jacket.

16. The apparatus of claim 14 wherein the cooling jacket, the renewable feed line, and the first atomizing gas tube are concentric.

17. The apparatus of claim 13 wherein the renewable feed line inlet to the FCC reaction zone is less than 10 m from the FCC feed inlet to the FCC reaction zone.

18. The apparatus of claim 13 wherein the renewable feed line further comprises a cooling gas inlet.

19. The apparatus of claim 13 further comprising:
an FCC atomizing gas tube surrounding the FCC feed line having an inlet and an outlet, the outlet of the FCC atomizing gas tube being in fluid communication with the FCC feed line outlet prior to the FCC reaction zone.
